(19) United States
(12) Patent Application Publication
(10) Pub. No.: US 2009/0041560 A1
(43) Pub. Date: Feb. 12, 2009

(54) LOCK NUT

(76) Inventor: Jukka Lunden, Kerava (FI)

Correspondence Address: FAY SHARPE LLP, 1100 SUPERIOR AVENUE, SEVENTH FLOOR, CLEVELAND, OH, 44114, US

(21) Appl. No.: 12/162,169

(22) PCT Filed: Jan. 24, 2007
(86) PCT No.: PCT/FI07/00021

§ 371 Date: Oct. 6, 2008

(30) Foreign Application Priority Data
Jan. 25, 2006 (FI) 20060070

(51) Int. Cl. F16B 39/32

(52) U.S. Cl. 411/194

(57) ABSTRACT

A lock nut includes a nut body in which there is a drill hole equipped with an internal thread for a bolt body equipped with an external thread. In the nut, there are provided essentially axial cuts which extend to the drill hole over part of its length. Locking claws are positioned in the cuts. The locking claws bite when pressed against the bolt to prevent the nut from opening. The cut is of such a shape that a fulcrum is created for the locking claw, with the aid of which the locking claw can be levered away from the bolt.

The present invention relates to a lock nut. More specifically, it relates particularly to a lock nut suitable for demanding applications.

In vibrating, moving, or otherwise demanding locations, in which there is a detachable joint, retention is usually ensured by using so-called lock nuts, which are intended to lock the attachment in place in such a way that vibration or other causes cannot make the nut begin to rotate open, simultaneously loosening the joint.

One way to do this, which is suitable for many purposes, though not for very demanding ones, it to use a nut in which some of the threads are formed of a slightly compressible plastic part, which is usually of nylon. The intention is that, when the nut is screwed into place, more force than usual must be used once the threads of the nut reach the nylon part. As stated, this solution works up to a certain point, but is not, however, suitable for demanding applications.

A way is also known, according to which transverse holes are made in the bolt while the nut is made longer than usual, in which case radial cuts are made starting from the end of the nut, so that a split pin pushed through the hole in the bolt, with its ends bent over, will prevent the nut from rotating. If the nut must be adjusted very precisely, it will be impossible to achieve sufficient precision in the adjustment in this way. Another drawback is the hole in the bolt.

The invention is intended to create a solution to the aforementioned drawbacks and manufacture a lock nut, which can be installed by stepless rotation and will automatically ensure that the nut will remain in the stated position.

In the following, the invention is examined in greater detail with reference to the accompanying drawings, in which:

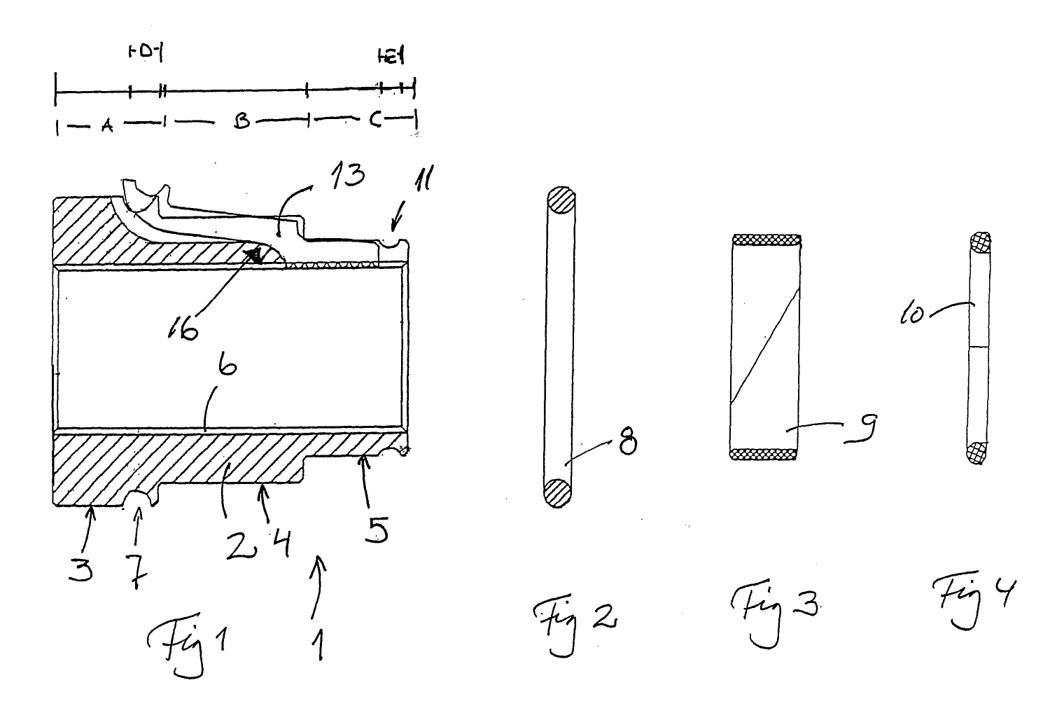

FIG. 1 shows a cross-section of the lock nut according to the invention;

FIG. 2 shows the lock ring that is used in the nut;

FIG. 3 shows the locking spring that is also used in the invention;

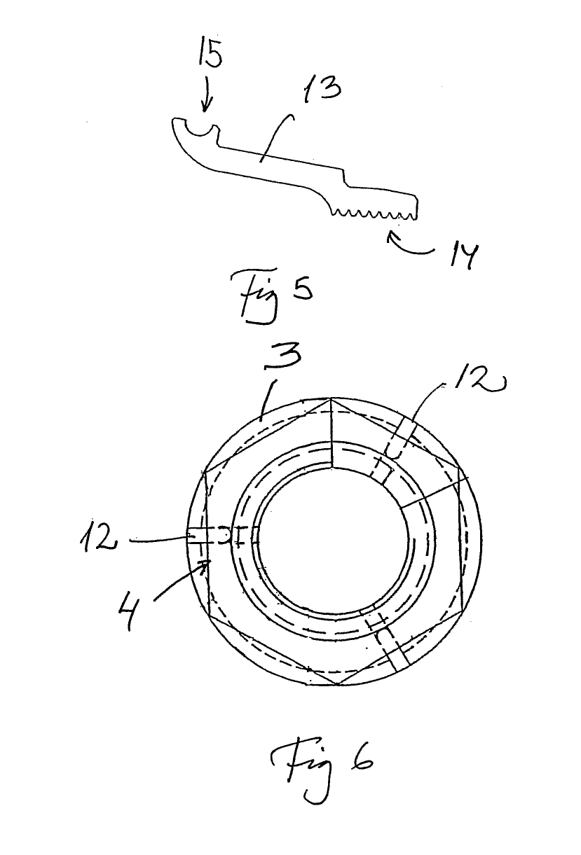

FIG. 4 also shows in turn a locking ring;

FIG. 5 shows a locking a locking claw; and

FIG. 6 shows an end view of the lock nut according to the invention.

Briefly, the lock nut according to the invention is longer that a conventional nut. At one end, it is split essentially radially in a few directions, while placed in the splits are locking claws, which under specific conditions bite into the surface/threads of the bolt onto which the nut is screwed. However, under other conditions biting into the surface does not occur.

In the following detailed description it will be best to follow both FIG. 1 and FIG. 6, as some aspects only appear in one or other of the figures.

Thus, FIG. 1 shows a cross-section of the lock nut 1 according to the invention, from which the components shown in FIGS. 2, 3, and 4 have been removed for reasons of clarity. The nut is formed of a body components 2, which is shown hatched in FIG. 1. In the conventional manner, a hole, in which there are essentially and unified internal threads 6, runs through the nut.

Generally, in the longitudinal direction the body is formed of three separate parts, of which the most extensive 3 can be of a desired shape, but nevertheless usually has a circular cross-section and a flange shape. This part is marked by the letter A in the line above the cross-section. Farthest from the edge on the said part is a groove D/7, in which it is intended to place a flexible ring 8.

The next part, which is marked on the line by the letter B and the number 4 in the cross-section, is shaped in its cross-section as, for example, a regular hexagon, thus permitting a suitable torque tool to be placed on top of it, in order to attach/open the nut. The shape can be other than a hexagon.

The third part C/5 has as essentially circular cross-section and is dimensioned to receive a spring ring 9 with an essentially corresponding dimension. Immediately next to the edge of the spring ring, when it is set in place, is a groove E/11, which it intended to receive a retaining ring 10, which can be, for example, of spring metal and which is intended to hold the spring ring 9, thus preventing it from dropping or moving.

The end-view in FIG. 6 shows clearly that there are three cuts 12 in the nut 1, which extend through the nut at its thinnest end, but which, towards the wider head of the nut, do not extend to the drill hole of the nut, though they are, of course, open at the outer surface of the nut. Locking claws 12 are placed in these grooves 12. A locking claw 13 is shown in the cross-section FIG. 1, but a separate view of it is also shown in FIG. 5. As can be clearly seen from FIG. 6, the grooves run in a direction that is nearly, but nevertheless slightly deviating from, radial, which alignment creates a situation, in which the edge of the claw 13 bites very well into the nut.

The locking claw is manufactured from high-grade metal. The part of it that faces the bolt is equipped with a thread, which in this case is, of course, only a small part of the thread, corresponding to that of the bolt. At the other end of the locking claw is a groove 15, corresponding to the groove 7 of the nut, and which is intended to receive the flexible ring 8.

The totality is assembled as follows. The locking claws 13 are placed in their grooves 12. The flexible ring 8 is set in place so that it lies in the groove 7 and at the same time into groove 15, holding the claws 13 in place. A suitable spring ring 9, fitting the part C/5 tightly, is now slipped into place, its retention being ensured by placing ring 10 into groove 11.

In the aforementioned assembly, the spring ring 9 presses the threaded ends of the locking claws to a slightly deeper position than they will take up once the nut has been screwed into place. The locking claws 13 change their position in such way that the part on the opposite side of point 16, which that acts as a fulcrum, i.e. of the end with the groove 15, is raised to some extent. The ring 8 permits this rise, as its force is clearly less than that of the spring ring 9.

When the nut 1 starts to be rotated into place on the bolt, the start can very well be made by rotating it by hand. Of course, a wrench can be used from the start, but nothing opposes rotation yet during the initial rotations. Once the nut is firmly in place, it is easy to place a suitable wrench on it, for example, one that sits tightly on top of the hexagonally shaped part B/4. The wrench will then also press the ends of the locking claws in the grooves, so that the threaded/grooved ends 14 will rise through the lever effect to a position in which they do not oppose the rotation of the nut. Once the desired tightness of the nut has been achieved, the wrench is removed, when the claws will press into the threads of the bolt and bite into them and the locking will be ready. If wished, the alignment of the locking claw can be slightly slanting, in order to improve the bite.

The material and dimensioning of the spring 9 are selected in such a way that they induce a sufficient pressure in the ends of the locking claws 13 against the bolt, but not an unnecessary large resistance to the torque tool being put in place. The ring 10 can be advantageously of metal, whereas the ring 8, because it is subject to no particular stress, can be, for example, a conventional rubber O-ring.

It is obvious that the invention is described above in the light of only a single example, and that this is not to be taken as a factor restricting the invention. Other possible variations in shape, position, and number are permitted, while nevertheless remaining within the scope of protection of the basic idea and the accompanying Claims.

1. Lock nut, comprising a nut body (2), in which there is a drill hole equipped with an internal thread for a bolt body equipped with an external thread, in which nut there is at least one essentially axial cut (12), which extends to the drill hole over part of its length, and a locking claw (13) in the said cut, to bite when pressed against the bolt, to prevent the nut from opening, characterized in that the cut (12) is of such a shape that a fulcrum (16) is created for the locking claw (13), with the aid of which the locking claw can be levered away from the bolt.

2. Lock nut according to claim 1, characterized in that the at least one cut (12) is in a direction that deviates slightly from the radial.

3. Lock nut according to claim 1, characterized in that the locking claw is elongated and equipped, in the area of the at least one cut (12) that extends to the drill hole, with a threaded part (14) corresponding essentially to the internal thread of the nut.

4. Lock nut according to claim 1, characterized in that the protrusion of the locking claw (13) in the area of the part (14) is such that a tightening device, such as a spring ring (9) brought to the said part (14) of the lock nut (1), will press the claw onto the bolt.

5. Lock nut according to claim 1, characterized in that the part of the arm away from the bolt part of the fulcrum of the locking claw (13) is raised from the surface, which is shaped to receive a torque tool.

6. Lock nut according to claim 2, characterized in that if desired the direction of the at least one cut is at a slant, in such a way that the edge, resisting the rotation of the nut, of the locking claw (13) set in the cut, is the first to come in contact with the surface of the bolt.

7. Lock nut according to claim 1, characterized in that there are at least two, and usually at least three cuts (12) and locking claws (13) corresponding to them.

8. Lock nut according to claim 1, characterized in that the part (4) of the nut (1) for a torque tool is a hexagon and that there are three cuts and claws, and that they are located in essentially the centre of every second side of the hexagonal part.
